(19) United States
(12) Patent Application Publication
(10) Pub. No.: US 2010/0280935 A1
(43) Pub. Date: Nov. 4, 2010

(54) System and Method for Creating and Managing Financially-Related Goals

(75) Inventors: Matthew C. Fellowes, Washington, DC (US); Stephen A. Wendel, Hyattsville, MD (US)

Correspondence Address: PILLSBURY WINTHROP SHAW PITTMAN, LLP, P.O. BOX 10500, MCLEAN, VA, 22102, US

(73) Assignee: HelloWallet, LLC, Washington, DC (US)

(21) Appl. No.: 12/773,495

(22) Filed: May 4, 2010

Related U.S. Application Data
(60) Provisional application No. 61/175,288, filed on May 4, 2009.

(51) Int. Cl. G06Q 40/00

(52) U.S. Cl. 705/35

(57) ABSTRACT

The invention provides computer-implemented behavioral science systems and methods for creating, managing, tracking, incentivizing, and/or reaching one or more financial health goals. The invention may include a software application supported by one or more computing devices that enables a website or other user interfaces that facilitate, inter alia, creation of financial goals, monitoring of financial goals, updating created goals for specific individuals using complex behavior modeling, and incentive structures based on behavioral science tailored and individualized for participants.

### CROSS-REFERENCE TO RELATED APPLICATIONS

This application claims the benefit of U.S. Provisional Patent Application No. 61/175,288, filed May 4, 2009, the contents of which are hereby incorporated herein by reference in their entirety.

### BACKGROUND OF THE INVENTION

1. Field of the Invention

The invention relates to computer-implemented systems and methods for creating, managing, tracking, and/or incentivizing financially-related goals.

2. Description of Related Art

Personal financial management is often handled by the average citizen in a “do it yourself” fashion. That is, many individuals and families deal with the day-to-day, month-to-month, and year-to-year management of their finances without a large amount of professional assistance.

Additionally, most individuals, families, and other entities develop one or more financial goals during their lifetime. For example, buying a home, starting a business, funding a child's education, funding a vacation, or funding retirement may be some of the more common goals that many individuals or families set out to achieve in their lifetimes. However, due to the aforementioned lack of professional assistance, many individuals or families have only vague conceptions and ill-defined plans for achieving those goals. As such, many of these goals are not realized and/or their achievement comes at a greater cost than initially expected.

The intricacies of planning and realizing mid-to-long-term financial goals can be immense. Shifting market behavior, asset or goal value fluctuations, changes in personal or family circumstances, and/or other intricacies make accurate planning and tracking of financial goals problematic. In some instances, even selecting what goals to strive for presents problems for certain individuals or families. Other problems also exist.

Current tools purporting to address problems in the area lack a comprehensive mathematical focus and as such, can lead individuals or families to make dire financial mistakes. For example, an individual may be directed to build retirement savings while taking on excessive credit card or installment debt. Furthermore, current tools may be designed for financially literate individuals/households, while evidence suggests that large shares of the U.S. population struggle to understand basic financial concepts. Furthermore, current tools do not integrate behavioral science into their processes, thus limiting their ability to provide truly useful features. Therefore, there exists a need for comprehensive, mathematically-focused, computer-implemented goal creation and management systems and methods.

### BRIEF SUMMARY OF THE INVENTION

The present disclosure relates to computer-implemented systems and methods for creating, managing, tracking, and/or incentivizing financially-related goals. Part of the challenge of financial goal-making is to provide a trusted, easy-to-use environment in which to learn about financial issues and be empowered to take specific action. The systems and methods of the invention bring a scientific approach to helping users meet their financial goals and recognize that the psychology of financial management is insufficiently addressed by current systems.

In some implementations, the invention may include a system for creating, managing, tracking, and/or incentivizing financial goals. A system according to the invention may include a computer software application that comprises one or more modules or components that provide various features and functions such as, for example, various user interfaces, the creation of goals, user-driven goal tracking, automated goal tracking and notification, behavioral modeling, assisting in the selection of appropriate goals (e.g., automated goal creation/recommendation), messaging, suggesting and managing incentives, integrating goals and incentives, user interface experimentation, data analysis, data normalization, data categorization, financial product selection/recommendation, and/or other features and functions.

In some implementations, the application may include and/or support one or more websites providing some or all of the features and functions described herein. Parts or all of the application may be accessible to one or more client devices via a computer network (e.g., the Internet or other network). In some implementations, the application may also interface with one or more incentive provider systems and/or financial services systems.

The one or more modules or components of the application may include a user interface module that generates/supports one or more user interfaces that enable users to create financially-related goals, manage existing goals, receive information about incentives, receive notification messages regarding existing goals and incentives, and/or otherwise enable user or administrator interaction with the features of the application. In some implementations, the user interface module may enable/support a dashboard interface that enables user access to the various goal-related features and functions described herein as well as general financial management features and functions that the system of the invention may be integrated with.

The application may also include a goal creation engine that enables internal creation and validation of goals, including the selection of appropriate questions and estimation of missing data for such goals, using, for example, a data analysis package.

In some implementations, the application may include an incentive engine based, at least in part, on behavioral science that enables aggregation of diverse incentive systems into a unified incentive framework. In some implementations, the incentive engine may select (or assist in selection of) appropriate incentives for a given user and/or goal and may award incentives upon completion of a goal and/or goal milestones. Through these functions, the application of the invention is able to shift the behavior of individuals towards behavior having more financially healthy characteristics. Because the behavioral science functions of the invention take into account a multitude of variables and/or incorporate an individual user's specific characteristics, the invention may provide individual users with customized and accurate financial behavior modification.

The application may also include a goal tracking engine that may assess user progress towards goals based on the current state of the user's financial assets, liabilities, and/or other information. In some implementations, the goal tracking engine may incorporate the relative priorities of goals and the allocation of monies or other assets to goals given these priorities. In some implementations, the goal tracking engine may supply goal status information to one or more user interfaces (e.g., for presentation to a user) and to a behavioral modeling engine. The behavior modeling engine may monitor user goal behavior and predict the likelihood of goal completion using statistical models of user behavior. In some instances, when a given user is unlikely to complete a goal, behavior modeling engine may select appropriate messages to encourage improvement. In some implementations, behavior modeling engine may execute a messaging engine to deliver those messages. The messaging engine may enable context-sensitive delivery of goal progress information and/or other information.

In some implementations, the application may include an experiment controller that enables system administrators to conduct controlled user-experience experiments on one or more users (e.g., a random selection of users) and track the responses/results of those users to improve system design and/or behavioral models, and/or perform other operations. In some instances, these experiments may serve to guide the behavioral science principles used to transform financially unhealthy individuals into healthy individuals.

In some implementations, the application may include a data analysis package that provides, inter alia, statistical tools for estimating missing or incomplete data, validating external data, forecasting user behavior, and/or provides other features.

As described herein, the application enables creation of financially-related goals. In some instances, the application utilizes one or more questions to assist in creation of a goal. For example, the application may present to a user (e.g., via a graphical user interface [GUI]) a series of questions tailored to a specific goal. The questions may be related to a user's financial situation, may be based on a user's preferences (e.g., which may have been provided to the application previously), and/or may be based on other information. The user may provide answers, which may be validated and then used to create a new goal (i.e., populate parameters for a new goal instance) for the user.

In some implementations, the application may enable a user to review and/or modify a goal at any time after creating the goal. For example, the application may provide one or more graphical user interfaces enabling a user to check the status of their goals, including the remaining steps or funds needed to achieve the goal, when the goal was created, when the goal is scheduled to be completed, and/or other status information. In some instances, the status information may include information relating to individual goals, information relating to goals falling within one or more categories, and/or information summarized across all goals. Goal status may be determined by the goal tracking engine, which may re-evaluate the valuation of the goal in real-time using real-time information from the data integration service.

In some implementations, the application may enable automated goal tracking and notification. For example, after creating one or more goals, a user may receive goal status notifications from the application. In some implementations, the status notifications may be provided on a regular basis and/or may be determined according to the user's preferences.

In some implementation, the application may employ behavioral modeling using data relating to one or more users. For example, some users may have difficulty fulfilling their goals because of, for example, changing financial circumstances, poor planning, overly high expectations, and/or for other reasons. Helping users to revise or attain their goals may not always be a straightforward task. Furthermore, advice that is poorly suited to the user may cause an outcome that is worse than no advice at all. In some implementations, the application may utilize behavior modeling to tailor its forecasting of goal performance and/or to tailor advice given when goals are not met, to maximize individual success.

To forecast goal achievement, the application may employ a predictive model of the likelihood of individual users completing a goal, given the goal type, financial target, and personal characteristics of the user. For example, a stored behavioral model associated with the user may be used to evaluate one or more of the user's goals. In some instances, the behavioral model may include data regarding the user's earnings, spending habits, investment, saving habits, and/or other data regarding the user and/or data regarding other users. A current value of a specific goal may be retrieved and a score may be generated for the goal in light of its associated user for its likelihood of failure. The messaging engine may then be utilized to alert the user and explain the significance of the score and/or provide suggestions as to how to modify behavior to better achieve the goal (if such modification is deemed necessary).

The application may also utilize behavioral models to generate and/or deliver one or more other notifications/messages to users. For example, in some instances, the application may employ a predictive model of the impact of goal-related messages on goal achievement (e.g., for individual messages and/or sequences of messages over time), given the goal type, financial target, goal progress, prior messages, and personal characteristics of the user. As such, one or more databases of the system of the invention may store a wide range of possible goal-related messages, and the application may use the predictive model to select the appropriate message. For example, if a user is failing to meet a goal to save for their child's college education at a particular school, the application can evaluate whether alternative schools would fit the user's requirements (leading to a “revise your goals” message), or whether the user has previously fallen behind on goals but eventually completes them (leading to a “you've done so well in the past” message). Messaging may also be used to notify users regarding other features of the application and/or to otherwise provide information or news to users. Intelligent message delivery may be employed to estimate/determine what messages to send, when to sent them, how to sent them, how often to send them, and/or other messaging parameters so as to increase the effectiveness/usefulness of messaging within the application.

As discussed herein, the application may also utilize behavioral models and/or other knowledge relating to one or more users to select appropriate and/or interesting goals (e.g., automatically generate/suggest goals). In some instances, the application may generate models and/or make determinations of which goals are likely to interest the user or likely to benefit the user financially, given the user's personal characteristics, including demographics, financial profile, and/or other information. The user may be able to access all (applicable) goals at will, but goals that are judged to be most compelling, beneficial, and/or appropriate for the user may be given prominence in a graphical user interface displayed to the user when the user is selecting goals or otherwise be presented to the user as suggested or preferred goals for new goal creation. Automated goal creation/recommendation may be part of one or more features that utilize predictive models in concert with user information to provide users with assistance or suggestions as to how to grow their wealth.

In some implementations, the application may recalibrate behavioral models of user behavior used by the features of the invention. To provide this functionality, the behavioral modeling engine may incorporate complete statistical and data mining (e.g., predictive market segmentation) capabilities to calibrate and apply behavioral models. In some instances, initial models may be developed outside of the application and subsequently embedded into a database of the system of the invention. In some implementations, as the application gathers data about user behavior, it may automatically recalibrate the behavioral models to incorporate the new data. As such, the behavioral modeling engine may track the accuracy of its own predictions, and may notify system administrators when its internal recalibration procedure is not achieving a predetermined expected increase in predictive accuracy. In some instances, the system administrators may then manually review the functional form for potential improvements, given the newly compiled behavioral data.

In some implementations, the application may enable suggestion and/or management of incentives related to goals. For instance, the application may be associated with one or more “partners” that may offer a diverse set of incentives to encourage users to complete their financial goals. The application may couple with and/or integrate with the disparate incentive systems of these partners to generate a common façade (i.e., interface) to all incentives. The application may then assist the user in selecting appropriate incentives based on personal characteristics and predicted performance on their goals after the incentives applied.

In some implementations, the application may enable the creation, editing, and tracking of special-purpose financial product plans, which may be considered financial goals as they provide a concrete plan for product purchase given a user's current needs. As such, this financial product recommendation/suggestion feature may be utilized in concert with manual and/or automatic goal creation/recommendation process described herein. One or more financial products may be selected for a financial product plan goal by analyzing user information and available financial product information to determine, which available financial products or group thereof would benefit the user and/or their already-created goals. For example, in some instances, a certain financial product (e.g., deposit account) may provide a better interest rate than one a user is currently using. In some implementations, a user may be able to edit and track progress against a previously determined financial product plan. This process may include notifications about changes in the availability and characteristics of products, or allow the user to re-execute product recommendation analysis given updated information with respect to savings and spending behavior. The application may provide for automatic notifications/messages to the user related to their financial product plan, and/or recommend new product plans based on the user information and product information described herein.

These and other objects, features, and advantages of the invention will be apparent through the detailed description and the drawings attached hereto. It is also to be understood that both the foregoing summary and the following detailed description are exemplary and not restrictive of the scope of the invention.

### BRIEF DESCRIPTION OF THE DRAWINGS

FIG. 1 illustrates an example of an environment having a system for creating, managing, tracking, and/or incentivizing financially-related goals according to various implementations of the invention.

FIG. 2 illustrates an example of configuration of a plurality of components of a system for creating, managing, tracking, and/or incentivizing financially-related goals according to various implementations of the invention.

FIG. 3 illustrates an example of a process for goal creation according to various implementations of the invention.

FIG. 4 illustrates an example of a process for goal achievement forecasting according to various implementations of the invention.

FIG. 5 illustrates an example of a process for behavior model recalibration according to various implementations of the invention.

FIG. 6 illustrates an example of a process for goal selection according to various implementations of the invention.

FIG. 7 illustrates an example of a system for aggregating and providing incentives in conjunction with financially-related goals according to various implementations of the invention.

FIG. 8 illustrates an example of a process for financial product selection/recommendation according to various implementations of the invention.

### DETAILED DESCRIPTION OF THE INVENTION

In some implementations, the invention may include a system for creating, managing, tracking, and/or incentivizing financial goals. As used herein, a financial goal may include a targeted financially-related action, event, state, or groups thereof to be achieved by a user or an entity including a user (e.g., a family). While a financial goal may include saving a specified amount of money, a goal may also include non-quantitative events such as, for example, “retirement,” “send child to college,” “buy a vacation home,” or other goals. As such, goals that are non-quantitative events may be associated with quantitative amounts. For example, the amount of money necessary to send a child to a given college or university may be associated with, inter alia, a quantitative dollar amount.

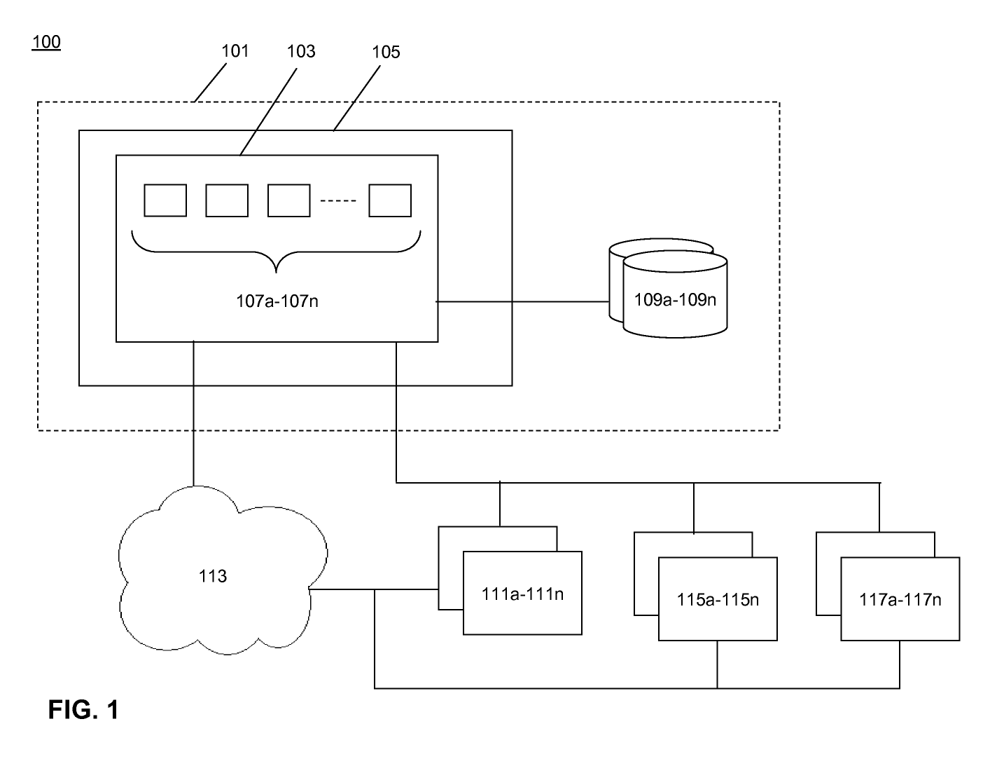

FIG. 1 illustrates an example of an environment 100 wherein a system 101 for creating, managing, tracking, and/or incentivizing financial goals may operate. System 101 may include a computer software application 103. In some implementations, application 103 may include or otherwise support a website and/or other computer implemented components. In some implementations, system 101 may include one or more computing devices 105 that run and/or support application 103. One or more computing devices 105 may be or include one or more servers, mainframes, desktop computers, laptop computers, mobile computing devices, and/or other computing devices. In some implementations one or more computing devices 105 may include one or more processors or processing devices and associated memory that are configured to perform the features and functions of the invention described herein and/or other features and functions.

In some implementations, various features and functions of application 103 or other parts of system 101 may be distributed across multiple networked computing devices 105, some of which may or may not be located in geographically similar areas.

In some implementations, application 103 may include one or more modules 107a-107n. Modules 107a-107n may provide one or more features and functions such as, for example, various user interfaces, creation of goals, user-driven goal tracking, automated goal tracking and notification, behavioral modeling, assisting in the selection of appropriate goals (e.g., automated goal creation/recommendation), messaging, suggesting and managing incentives, integrating goals and incentives with system 101, user interface experimentation, data analysis, data normalization, data categorization, financial product selection/recommendation, and/or other features and functions.

As described herein system 101 may include one or more databases 109a-109n, which may include one or more relational databases and/or directory systems and any necessary data storage devices. Other types of data storage and/or memory systems and methodologies may also be used.

As described herein, in some implementations, application 103 may include and/or support one or more websites providing some or all of the features and functions described herein. In some implementations, some or all of application 103 and/or its constituent modules 107a-107n may be loaded onto a client device (e.g., 111), such that some or all of the features and functions of the invention run locally on a user's client device. In implementations wherein features and functions of the invention run locally on a client device, interaction with a remote “server” (e.g., one or more computing devices 105) may occur to provide support and/or additional functions of application 103. In some implementations, some of the features and functions described herein may run locally on a user's client computer (e.g., 111), while others may run on a remote server (e.g., 105). In some implementations, the features and functions described herein may run on a central server (e.g., 105) of system 101 which may provide functionality across a network to user operating client computers (e.g., 111a-111n).

In some implementations, parts or all of application 103 may be accessible to one or more client devices 111a-111n via a computer network 113. In some implementations, one or more client devices 111a-111n may interface directly with system 101. Client devices may be used by one or more users and/or system administrators to access/interface with application 103 and may include one or more servers, desktop computers, laptop computers, handheld computers, smart-phones, cell phones, personal digital assistants, and/or other computing devices. Network 113 may include any one or more of, for instance, the Internet, an intranet, a PAN (Personal Area Network), a LAN (Local Area Network), a WAN (Wide Area Network), a SAN (Storage Area Network), or a MAN (Metropolitan Area Network). Any suitable communications link may be utilized, including any one or more of, for instance, a copper telephone line, a fiber-optic line, a Digital Subscriber Line (DSL) connection, a Digital Data Service (DDS) connection, an Ethernet connection, an Integrated Services Digital Network (ISDN) line, an analog modem connection, a cable modem connection, a wireless connection, a cellular connection, a high-bandwidth-short-range connection (e.g., Bluetooth™ connection), and/or other connection.

As described herein, in some implementations, system 101 may also interface with one or more incentive provider systems 115a-115n, which may be or include one or more servers, mainframes, desktop computers, laptop computers, handheld computers, smart-phones, mobile computers, and/or other computing devices. One or more of the incentive provider systems 115a-115n may interface with system 101 via network 113 and/or may interface directly with system 101.

In some implementations, system 101 may interface with one or more financial services systems 117a-117n to receive information relating to a specific user's finances (with the user's permission), interest rates, and/or other financial information used by the invention. Financial service systems 117a-117n may include the computer systems (e.g., servers, mainframes, desktops, laptops, mobile computers, etc.) of financial service entities or other entities such as, for example, banks, credit unions, insurance companies, brokers, dealers, investment related entities, credit card companies, mortgage companies, loan (e.g., student, auto, commercial, etc.) providers, utility companies and/or their billing agencies, membership organizations, subscription service providers (e.g., music/video clubs; a hypothetical goal analysis may analyze subscription expenditures, ascertain if they are efficiently used, and determine if a shift to a more cost effective use of income is possible), asset valuation services (e.g., home valuation, car valuation, art valuation, tuition pricing valuation, expected rental pricing, and/or other valuation services), government agencies (e.g., U.S. Department of Housing and Urban Development, U.S. Federal Reserve System, U.S. Census Bureau), stock exchanges, futures markets, and/or other financially-related entities. In some implementations, obtaining information regarding a user from systems 117a-117n may include interpreting, reformatting, and/or categorizing raw data received from a given system 117 into information usable by the various components of system 101.

In some instances, systems 117a-117n may fall into one or more of categories of services/entities: i) those related to what a user owes, ii) those related to what a user owns, iii) what a user may be expected to pay to make a future purchase related to a particular goal, and iv) the current, historical, and forecasted future characteristics of the financial environment (e.g., interest rates, rental costs, minimum loan requirements, etc.). Other categories may be used.

In some implementations, information related to a user that is not necessarily financial information may be obtained from systems 117a-117n or otherwise obtained by system 101. This other information relating to a user may include personal information (e.g., name, age, address, gender, marital status, number of children/dependents, etc.) demographic information (e.g., race/ethnicity), or other information that is not necessarily financially related.

In some implementations, certain financial or other information may be derived from system 101's interface with financial service systems 117a-117n (which may be via a direct interface or an interface via network 113) and/or may be provided by a user to system 101 directly through, for example, a graphical user interface (e.g., a user answering questions through a GUI). In some implementations, a data integration service (e.g., 107j) of application 103 may facilitate interaction between system 101 and financial service systems 117a-117n. Application 103 may interact and/or integrate with these disparate financial service systems 117a-117n to generate simplified façades (i.e., interfaces) to access any required/desired data. Component financial service systems may themselves aggregate and provide a unified interface to other financial service systems. Application 103 may employ financial service system-specific application programming interfaces (accessed via one or more protocols such as, for example, SOAP [Simple Object Access Protocol], REST [Representational State Transfer], and RPC [Remote Procedural Protocol]), may harvest information semi-automatically from a system's websites, and/or may provide an interface for manual data entry. In some implementations, application 103 may assess the quality and/or consistency of data received from financial services systems 117a-117n using associated data analysis tools.

In some implementations, the invention provides modules and methods for enhanced/robust intake of information from financial services systems 117a-117n or other third party computer systems. For example, data integration service 107j or other component of application 103 may include a normalization component. The normalization component may acquire or receive raw data from a system in a format native to or otherwise used by that system. The normalization component may then recognize the underlying information in the raw data (e.g., account no. transaction type, beginning balance, ending balance, etc.) and may store the underlying information in databases 109a-109n in a format understandable by the various components of system 101.

In some implementations, the normalization component or other portion of data integration service 107j or application 103 may include an auto-categorization component that may categorize the normalized information from third party sources into predefined categories within system 101. For example, information from a credit card or checking account may be obtained, normalized and categorized (e.g., food expenses, entertainment, business expenses, etc.) such that system 101 knows what the user's spending habits are. This information may be used with other features of the invention as described herein and otherwise. The normalization and auto-categorization components may enable efficient and reliable receipt of information relating to the finances of users, the characteristics of financial products, and/or more robust use of other information. For example, when gathering financial information regarding a user from interfaces with the user's financial institutions, the normalization and auto-categorization components may be able to receive information from a myriad of different systems utilizing different formats (e.g., raw data formats, naming conventions, categorizations, etc.) and mine the maximum amount of information there from so as to provide more robust features to the user (e.g., goal creation/modification, goal encouragement, goal recommendation, financial product recommendation, and other features may be more effective when information is complete and adequately categorized).

In some implementations, these normalization and auto-categorization components may function without direct user intervention and automatically process incoming data. Information is mined, categorized, and stored (e.g., in databases 109a-109n) transparently to the user. In some implementations, when data regarding a user is received, normalized and categorized as described herein, a message may subsequently be sent to a user containing the normalized and categorized information. In some implementations, mined information may be made accessible and editable (e.g., for validation/correction) by a user via one or more GUI's. As discussed herein such normalized and categorized information may be utilized for internal purposes (e.g., goal creation, goal updates, etc.)

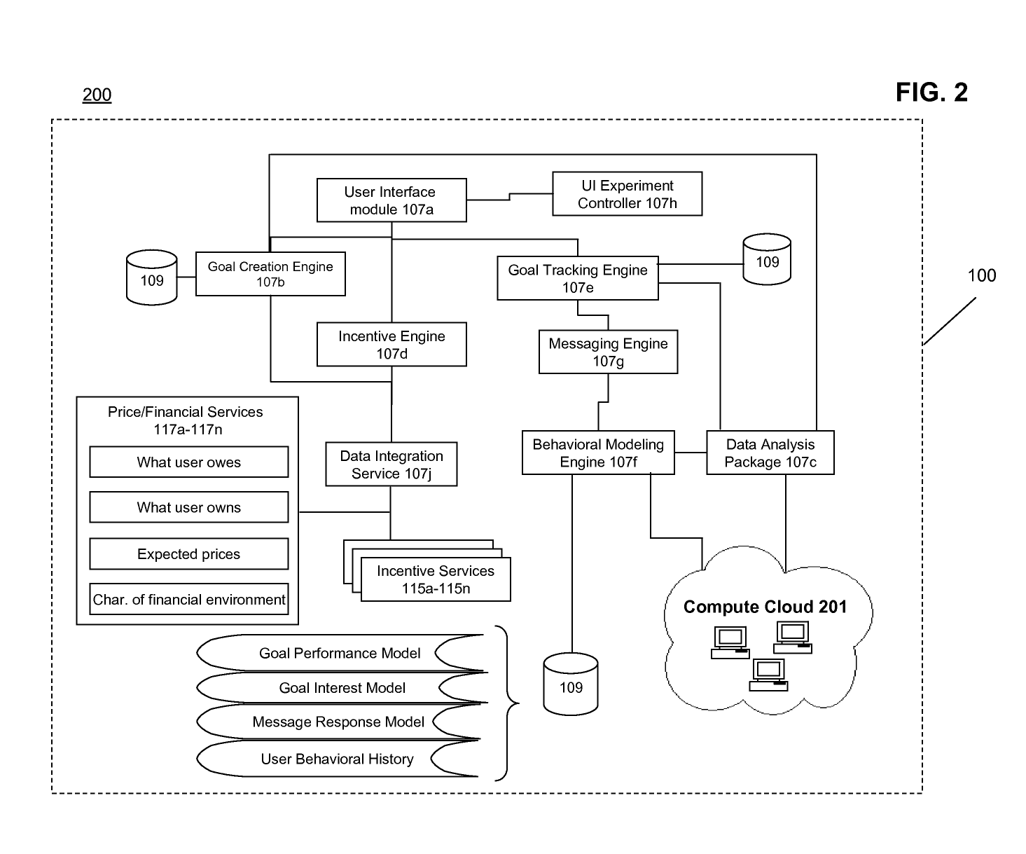

FIG. 2 illustrates an example of a configuration 200, wherein certain modules 107 of application 103 are shown relative to one another, other system components, and other elements of environment 100. Other configurations may be used. While certain components of system 101 are described as “module,” “engine,” “service,” “controller,” or other label, it will be understood by those having ordinary skill in the art that these components can be implemented as one or more software/firmware modules, routines, processes, and/or other computer-implemented elements that may be used to configure one or more computer processors to perform the features and functions of the invention described herein. Furthermore, while FIG. 2 illustrates various connections between elements within environment 100 which may demonstrate communication or interaction between various elements therein, the configuration of FIG. 2 is to be understood as exemplary only and various components of environment 100 may communicate or interact directly or indirectly with one another according to other configurations as necessary or desired even though such connections may not be illustrated in FIG. 2. In some implementations, the systems and methods described herein may utilize other modules not illustrated in FIG. 2.

In some implementations, as illustrated in configuration 200, system 101 may include a user interface module 107a that generates/supports one or more user interfaces (e.g., graphical user interfaces—GUIs) that enable users to create financial related goals, manage existing goals and financial information, receive information about incentives, receive notification messages regarding existing goals and incentives and/or otherwise interact with system 101. In some implementations, user interface module may support a dashboard-like interface whereby a user is presented with one or more categories of information and/or features provided by system 101. The user may then select which information/features to interact with (e.g., using a mouse or other input device associated with their user system 111) and may be presented with a sub-interface including the selected information/functions, while retaining the overall dashboard interface. In some instances, a user may customize the interfaces by providing input as to what information to display, where to display it and/or other preferences.

In some implementations, user interface module 107a may be supplied with information to be displayed by a goal creation engine (e.g., 107b), an incentive engine (e.g., 107d), a goal tracking engine (e.g., 107e), an experiment controller (e.g., 107h), databases 109a-109n, and/or other components of system 101.

In some implementations, system 101 may include a goal creation engine 107b that enables internal creation and validation of goals, including the selection of appropriate questions and estimation of missing data for such goals, using a data analysis package 107c. In some implementations goal creation engine may include and/or be associated with a database 109 for storing created goals and/or other associated information. In some implementations, goal creation engine 107b may receive user information and goal metadata from database 109, store new goals to database 109, employ data analysis package 107c to generate estimates and a data integration service (e.g., 107j) to attain goal valuations (houses, cars, etc), and/or perform other functions as described herein. In some instances, goal creation engine 107b may trigger a messaging engine (e.g., 107g) upon creation of the goal.

In some implementations, system 101 may include an incentive engine 107d that enables aggregation of diverse incentive systems into a unified incentive framework. In some implementations, incentive engine 107d may utilize behavioral sciences theory/models in the performance of one or more of its functions. In some implementations, incentive engine 107d may select (or assist in selection of) appropriate incentives for a given user and/or goal. In some implementations, incentive engine 107d may award incentives upon completion of a goal and/or goal milestones and/or may perform other functions. In some implementations, incentive engine 107d may receive information regarding potential incentives from a data integration service (e.g., 107j), supply processed and/or filtered incentives to a user interface, and/or may perform other functions as described herein. In some instances, the features of incentive engine 107d may enable transformation of behavior towards behavior having more financially healthy characteristics.

In some implementations, system 101 may include a goal tracking engine 107e that may assess user progress towards goals based on the current state of the user's financial assets, liabilities, and/or other information. In some implementations, goal tracking engine 107e may incorporate the relative priorities of goals and the allocation of monies or other assets to goals given these priorities. In some implementations, goal tracking engine 107e may supply goal status information to one or more user interfaces (e.g., for presentation to a user) and to a behavioral modeling engine 107f. In some implementations, goal tracking engine 107e may be associated with a database (e.g., 109) that stores goal-tracking-related information such as, for example, goal information, user asset/liability information, and/or other information. In some implementations, goal tracking engine 107e may retrieve goal and/or incentive information from database 109, employ a data analysis package (e.g., 107c) to estimate missing data, execute a behavioral modeling engine (e.g., 107f) to predict goal performance, interest, and response to notification messages, and/or may perform other functions as described herein. In some implementations, goal tracking engine 107e may trigger a messaging engine (e.g., 107g) when goal success is in jeopardy. Goal tracking engine 107e may also call incentive engine 107d to award incentives when incentive milestones are reached.

Behavior modeling engine 107f may monitor user goal behavior and predict the likelihood of goal completion using statistical models of user behavior. In some instances, when a given user's completion of a goal appears to be in jeopardy, behavior modeling engine 107f may select appropriate messages to encourage improvement. In some implementations, behavior modeling engine 107f may execute a messaging engine 107g to deliver those messages. In some implementations, behavior modeling engine may access database 109 to retrieve stored models (e.g., goal performance models, goal interest models, message response models, and/or other models) and behavioral records, and may score users with these models via a data analysis package (e.g., 107c) and/or a compute cloud (e.g., 201). In some instances, behavior modeling engine 107f may recalibrate these and other models, as needed, and may perform other functions as described herein.

In some implementations, system 101 may include an experiment controller 107h that enables system administrators to conduct controlled user-experience experiments on one or more users (e.g., a random selection of users) and track the responses/results of those users to improve system design and/or behavioral models, and/or perform other operations. In some instances, these experiments may guide the behavioral science used to transform financially unhealthy individuals into healthy individuals.

In some implementations, messaging engine 107g may enable context-sensitive delivery of goal progress information and/or other information. For a given message request (e.g., from behavioral modeling engine 107f, goal creation engine 107b, goal tracking engine 107e, and/or other modules 107a-107n or elements of system 101), messaging engine 107g may determine where and when to provide that message to the user. For example, messaging engine 107g may generate, receive, derive, or otherwise determine one or more delivery options for a given message. In some instances, delivery options may include delivery to a user interface (e.g., an online interface) enabled by user interface engine 107a, delivery via a text message to a user device, via an email to a user's email account, and/or other delivery options. In instances where a message is delivered to a user interface, messaging engine 107g may inject content into a user interface created by and displayed by system 101 at one or more extension points (i.e., programmatically-specified locations in the user interface wherein it may be appropriate to supply the user with relevant messages). In some implementations, messaging engine 107g may utilize user-specified preferences on when and how to receive messages. In some implementations, user-specified preferences may be received by a graphical user interface of system 101.

In some implementations, system 101 may include a data analysis package 107c that provides, inter alia, statistical tools for estimating missing or incomplete data, validating external data, forecasting user behavior, and/or provides other features.

In some implementations, system 101 may include a data integration service 107j that provides a real-time interface to external data providers (e.g., incentive service systems 115a-115n and financial service systems 117a-117n) employed in goal creation engine 107b, goal tracking engine 107e, incentive engine 107d, and/or other portions of system 101. Integrated data sources include may provide, for example, information relating to assets or potential assets (e.g., asking prices, etc. for homes; purchase price, etc. for cars; and/or other information), information relating to tuition prices, information relating to incentive offerings, information relating to national and regional interest rates, or other information provided by outside sources. As discussed herein, integrated data sources may fall into one or more categories such as, for example, those related to what a user owes; those related to what a user owns; those related to what a user may be expected to pay to make a future purchase related to a particular goal; those related to the current, historical, and forecasted future characteristics of the financial environment (e.g., interest rates, rental costs, minimum loan requirements, etc.); those related to incentives; and/or categories. Also as discussed herein, data integration service 107j may include a normalization component and/or an auto-categorization component for extracting and intelligently utilizing information from third party sources.

In some implementations, system 101 includes an internal database 109 that stores some or all of the information described above including information relating to goals, instances of goals for specific users, incentives, preferences (e.g., alert preferences, display preferences, or other preferences), membership in savings clubs, historical progress on goals, account status, financial information regarding users, personal information regarding users, information relating to financial products, and/or other information.

In some implementations, system 101 enables creation, storage, and management of financially-related goals. For example, to facilitate the creation and population of a new goal instance, application 103 may present to a user (e.g., via a graphical user interface) a series of questions. For example, in some instances, the questions may be tailored to a specific goal, may be related to a user's financial situation, may be based on a user's preferences (e.g., which may have been provided to system 101 previously), and/or may be based on other information. In some implementations, system 101 may store (e.g., in database 109) one or more predefined goals. The user may be presented a list of the predefined goals and may be able to choose which goal for which to begin creation. In some implementations, the list of possible goals presented to the user may be filtered based on information (e.g., financial information, personal information, or other information) known about the user. The user may provide answers to the questions (and system 101 may receive the answers). Application 103 may then validate the data from the provided answers and store the newly created instance of the goal in database 109 or elsewhere in system 101.

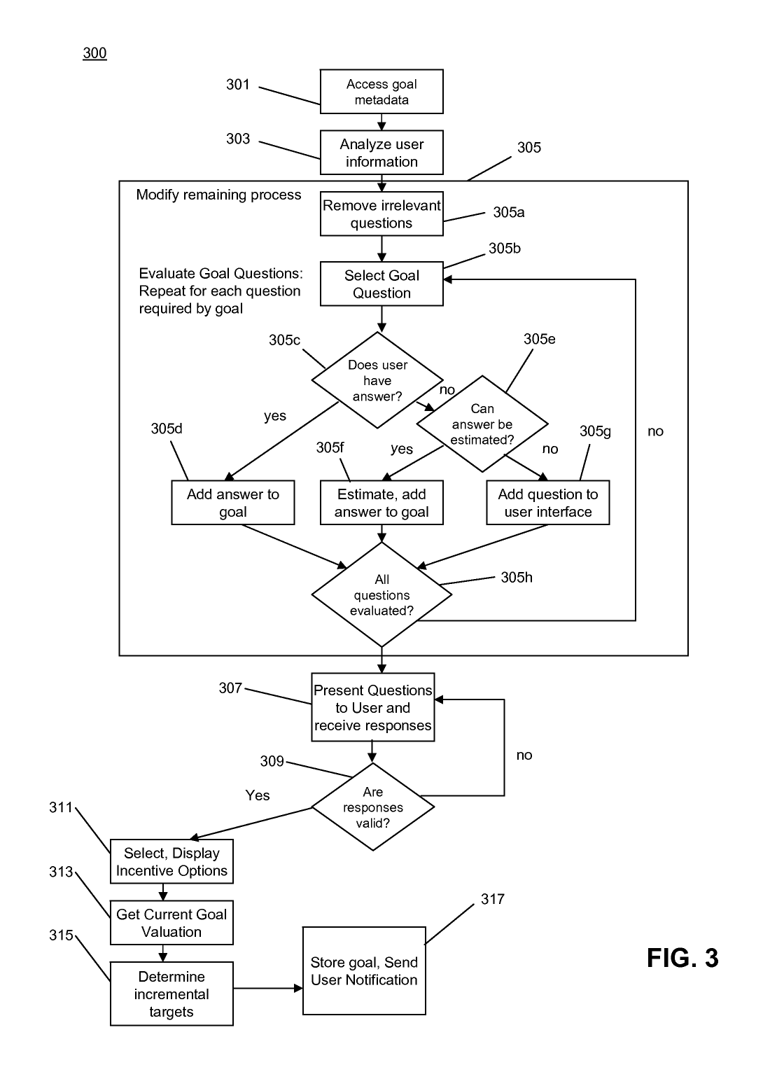

FIG. 3 illustrates a process 300, which is an example of a process enabled by system 101 wherein one or more financially-related goals are created. Process 300 may include an operation 301, wherein application 103 accesses metadata regarding a specific goal from an internal database (e.g., database 109) to determine what information is needed from a user to create this specific goal. In some implementations, such metadata may include, but is not limited to, a goal type, a list of questions and information required to create a goal, criteria by which to assess whether a user should be offered a goal (e.g., whether multiple goals of the same type can be created, whether a user must have children to create a particular goal, whether a user must own a house to create a particular goal, etc.), a default duration/maturity date and/or value of a goal, criteria by which to select appropriate incentives for a goal (e.g., whether incentives relating to homeowners should be applied), and/or other metadata.

In an operation 303, application 103 may analyze any information currently stored about the user. In some instances, this may serve to exclude irrelevant questions and/or fill in information that is already known by system 101. As such, in an operation 305, the information gleaned from operation 303 may be used to modify the remaining questions. For example, in some instances, sufficient information may be available to infer answers to some of the pre-prepared questions. In these instances, data analysis package 107c may utilize this information to estimate these values. In some instances, when information is not available on the particular user but comparable information is available on other relevant users, data analysis package 107c may estimate values/answers to questions based on aggregate information from other relevant users.

FIG. 3 illustrates that operation 305 may comprise/include various operations such as, for example, operation 305a wherein questions deemed irrelevant (e.g., in light of user information) may be removed. Process 300 may also include operations wherein each remaining question required to be answered for the particular goal is evaluated. Evaluating goal questions may include an operation 305b, wherein a goal question from the remaining goal questions is selected for evaluation. In an operation 305c, it is determined if the user information (e.g., information already known about the user) supplies an answer to the selected question. If the user information does supply the answer, then the answer is added to the stored information for the created goal for the user in an operation 305d. If the user information does not supply the answer, it is determined, in an operation 305e, whether the answer can be estimated (e.g., using the user information or other data). If the answer can be estimated, the estimation is made and the estimated answer is added to the stored information for the created goal for the user in an operation 305f. In some implementations, estimated information may be marked/tagged as estimated. In some implementations, the mark/tagging of estimation may include the underlying information used to make the estimation along with the mechanism/process used to make the estimation. If it is determined that the answer cannot be estimated, the question is added, in an operation 305g, to a user interface that is used to present questions to and receive answers from the user. In an operation 305h, it is determined whether all of the remaining goals are evaluated. If all of the questions have been evaluated, process 300 proceeds to operation 307. If more questions remain, process 300 returns to operation 305b, wherein an additional question is selected for evaluation.

The process of evaluating goal questions may serve to populate the characteristics, metrics, and/or parameters of a given instance of a goal using known or estimated information.

In an operation 307, the set of questions for which answers are needed are presented to the user via the user interface. Answers to the questions presented may then be received by application 103 via the user interface. Examples of questions related to goals include questions for identifying a name for the goal (e.g., Betty's Harvard Tuition), a timeline/maturity date for the goal (e.g., when will Betty need to enroll in college?), questions identifying the priority of current financial expenditures (e.g., entertainment spending is less important than a gym membership, therefore, the goal may include suggestions diverting entertainment expenses to etc.), questions identifying pertinent characteristics of a goal instance (e.g., Betty wants to go to Harvard) and/or other questions. Another example of a type of question is questions concerning allocation of funds to the goal. In these types of questions, the user is asked to allocate a percentage of current and future funds towards the goal. Application 103 may then automatically determine the quantity of unallocated funds based on the user's account information and existing goal set. Other questions or types of may be used in goal creation to populate instances of goals with pertinent parameters and characteristics.

In an operation 309, received user responses may be validated. In some instances, validating a response includes determining whether the response/answer is consistent with other data (e.g., if the goal is related to college savings for a child who is currently 2 years of age, and answer to a question regarding expected graduation date should indicate that the child will be of an age wherein graduation from college is expected). In some instances, validating a response includes determining whether the response/answer generally makes sense in light of the question asked (e.g., of a question related to an age for retirement, the answer is expected to be a number). Other types of validation may be performed. If the data is determined to be invalid, application 103 may provide the user with an error message and may return to operation 307 wherein corrected information is requested.

In some implementations, when the responses are complete and valid, application 103 may, in an operation 311, execute incentive engine 107d to determine appropriate incentives to apply to the user for this goal (see below for full description). Such incentives may include, for example, coupons, sponsorships, or merchandise. Application 103 may display a list of possible incentives and goal milestones required to attain the incentives via a graphical user interface. The user may select some or all of the incentives (and/or milestones) that he/she wishes to work towards.

In some instances, one or more financial products may be evaluated in light of the created goal to determine whether the one or more products may benefit the user in achieving the goal. For example, system 101 may store (e.g., in database 109) information regarding a set of financial products. The parameters of the created goal may be applied to the information regarding the financial products to select one or more products that may further achievement of the goal. Any selected products may then be presented to the user as described herein.

In an operation 313, application 103 may utilize data integration service 107j to provide real-time valuations related to the goal. For example, if a user creates a house-savings goal, application 103 may query external data providers (e.g., Zillow, Cyberhomes, etc.) for the exact current value of the home the user seeks to purchase. In other instances, if a college savings goal were created, application 103 would retrieve information related to the costs associated with attending the college/university specified as part of goal creation (e.g., estimated tuition of the specific school, estimated cost for books/supplies, estimates for housing, etc.) As discussed herein, data integration service 107j may also be used to receive/retrieve real-time information related to a user's financial status or other information regarding a user (e.g., value of assets, debts, etc.) from one or more financial services systems 117a-117c or other entities. In some implementations, data may be obtained constantly (e.g., regarding users, valuations, costs, market circumstances, etc.) to update the parameters of an instance of a goal.

In an operation 315, application 103 may determine incremental targets (e.g., monthly savings targets) and/or other actions required to meet the goal, based on the future value of the goal, the interest to be earned on savings, and/or other factors, as appropriate. In some instances, the future value of the goal may be calculated based on an expected appreciation of the item sought for the goal. For example, application 103 may calculate an increase in tuition costs for a ten-year education savings goal. In another example, a credit card debt reduction goal may incorporate additional monthly fees paid until the goal is met. Other future value calculations or other calculations may be performed and incorporated into the goal.

In some implementations, interest on savings or other earnings on assets used to fund the goal may also be calculated for each asset associated with the goal. For example, if the user has a savings account that is dedicated towards achieving a goal, the interest earned on that account may be factored into funding the goal at the “maturity date” of the goal (i.e., when the funds are needed to be put into action for the goal). Other increase (or decrease) in the value of assets may be estimated and/or projected at a given point in time and factored into the parameters of a goal. In some implementations, interest or increase in value may be compounded according to the terms and conditions of that account. For example, if a savings account is used to hold money for a goal, it will generally earn higher interest than a checking account, and thus the amount of money that must be saved each month to meet the goal may decrease according to interest calculations. As described herein, data integration service 107j may be used to access information relating to interest rates, projected values, market conditions, from one or more outside systems (e.g., financial services systems 117a-117n).

In an operation 317, application 103 stores the goal instance and its associated information in database 109, making it available for tracking by a user via a graphical user interface, and triggering messaging engine 107g to alert that the goal has been started. The actions determined to be necessary and/or desirable to achieve the goal, may be stored in databases 109 as part of the goal instance. As discussed herein the one or more actions may include diverting funds from one or more sources into an account or other financial product according to a defined schedule, making payments to a debt on a given schedule, selling one or more assets, or other defined actions. In some implementations, the defined actions may include a defined sequence and/or other timing parameters.

In some implementations, application 103 may enable a user to review and/or modify a goal at any time after creating the goal. For example, application 103 may provide one or more graphical user interfaces enabling a user to check the status of their goals, including the remaining steps or funds needed to achieve the goal, when the goal was created, when the goal is scheduled to be completed, and/or other status information. In some instances, the status information may include information relating to individual goals, information relating to goals falling within one or more categories, and/or, information summarized across all goals. Goal status may be determined by goal tracking engine 107e, which may re-evaluate the valuation of the goal in real-time using real-time information from data integration service 107j (e.g., data regarding the parameters of goals may be updated regularly and the changes that such updates induce may be propagated as part of each goal instance). Re-evaluation may also include updating the one or more defined actions and/or the sequence (or other timing parameters/schedules) associated with those actions commensurate with the additional/updated information.

In some instances, additional information that is used to update a goal instance, its parameters and/or defined actions to be performed for completion may include the non-performance of a defined action and/or the partial performance of a defined action. For example, if a defined action includes diverting a given amount during a given pay period into a college savings account, and a user fails to do so, the associated goal may be updated to reflect what the user needs to do to cure this deficiency. The update may provide the user with one or more options for curing the deficiency, such as, for example, curing the deficiency all at once or doing so over a period of time.

In some implementations, application 103 may provide one or more graphical user interfaces enabling users to review incentives related to a goal, including a list of outstanding incentives and/or awarded incentives. In some instances, the one or more interfaces may enable a user to review how far the user is from winning the outstanding incentives, as provided by incentive engine 107d.

In some implementations, application 103 may enable a user to customize the appearance (i.e., via the one or more interfaces) of the goals, including, for example, a name and/and or picture associated with the goal.

In some implementations, application 103 may enable users to join competitions, savings clubs, and other communal activities with other members/users on application 103 who have similar goals or other common interests. In some instances, application 103 may automatically determine a set of existing communal activities that may be appropriate for a particular user. In some instances, the user also has the option of initiating communal activities.

In some implementations, application 103 may provide one or more graphical user interfaces enabling a user to modify parameters associated with a goal. For example, a user may be able to change an allocation of money toward one or more of their existing goals, which may trigger a recalculation of goal status by goal tracking engine 107e. Other parameters may also be altered. For example, a user may change a date of goal “maturity,” a characteristic of the goal (e.g., switch goal university from Harvard to Stanford) or other goal parameter, which then results in propagation of any changes through the goal instance definition. In some implementations, application 103 may provide one or more graphical user interfaces enabling a user to delete one or more existing goals.

In some implementations, changes to goals, participation in communal activities, and/or other changes may be stored in an internal database (e.g. one or more databases 109a-109n).

In some implementations, application 103 may enable automated goal tracking and notification. For example, after creating one or more goals, a user may receive goal status notifications. In some implementations, the status notifications may be provided on a regular basis and/or may be determined according to the user's preferences. For instances, when a user sets up a goal, the user may set one or more preferences such as, when to receive notifications (e.g., weekly, monthly, etc.), how to receive notifications (e.g., to an email address, etc.), a threshold for the likelihood of goal failure (or difficulty) at which to receive notifications, whether to receive notifications about other goals that may impact a given goal, whether to receive notifications about the aggregate success of other users associated with similar goals, and/or other preferences. For example, in some implementations, application 103 may enable a user to set (e.g., via the user's preferences) whether they would like to receive updates from application 103 about one or more of their goals, and, if so, to choose the mode of contact. In some instances, possible modes of contact may include: alerts within an online user interface provided by application 101, text message alerts, email alerts, alerts via phone messages, and/or other modes of contact. As discussed herein, application 103 enables a user (e.g., via the user's preferences) to set the frequency of notifications. In some implementations, application 103 may enable a user (e.g., via the user's preferences) to set the level of detail of any notifications.

In some implementations, messages may be delivered (or filtered out) to a given user according to a determination of the likelihood that a user will read the message and/or take action based on the message. For example, behavioral modeling data for a user (or similar users) may be used to determine whether a given message includes information likely to interest a user and/or prompt a user to act based on the content of the message. The wealth of data gathered by system 101 regarding the user may be used to construct these behavioral models, as described herein. System 101 may also “learn” to predict the effectiveness of a given message based on previous user responses to messages (e.g., storing previous user responses and surrounding circumstances).

In some instances, based on these preferences, messaging engine 107g may processes requests from goal tracking engine 107e to determine when the user should be provided with one or more notifications. When it is determined that one or more notifications should be sent, messaging engine 107g delivers the notifications according to a specified mode of contact. As described herein, goal tracking engine 107e may re-evaluate the valuation of one or more goals in real-time using data integration service 107j. Goal tracking engine 107e may also re-evaluate progress towards goals, sufficiency of current savings, and/or other factors according to real-time data. Messaging engine 107g may also generate and send one or more messages relating to a user's accounts in general (e.g., as part of an overall financial management system), suggested courses of action (e.g., independent of any specific goals), general financial or other news, available financial products, and/or other messages. These other messages may also be managed according to timing and delivery preferences and/or may otherwise be filtered or handled similar to goal-related messages described herein.

In some implementations, system 101 may include predefined types of messages (or “alerts”) that may be generated based on variables, changes of market conditions, user information, goals associated with a user, and/or other factors. Users may

In some instances, application 103 or other element of system 101 may employ behavioral modeling using data relating to one or more users. For example, some users may have difficulty fulfilling their goals because of, for example, changing financial circumstances, poor planning, overly high expectations, and/or for other reasons. Helping users to revise or attain their goals may not always be a straightforward task. Furthermore, advice that is poorly suited to the user may cause an outcome that is worse than no advice at all. In some implementations, application 103 may utilize behavior modeling to tailor its forecasting of goal performance and/or to tailor advice given when goals are not met, to maximize individual success.

As described herein, behavioral modeling engine 107f may analyze data from the internal databases and/or external data to forecast goal achievement, select appropriate notification content, automatically select/suggest goals, and/or perform other features.

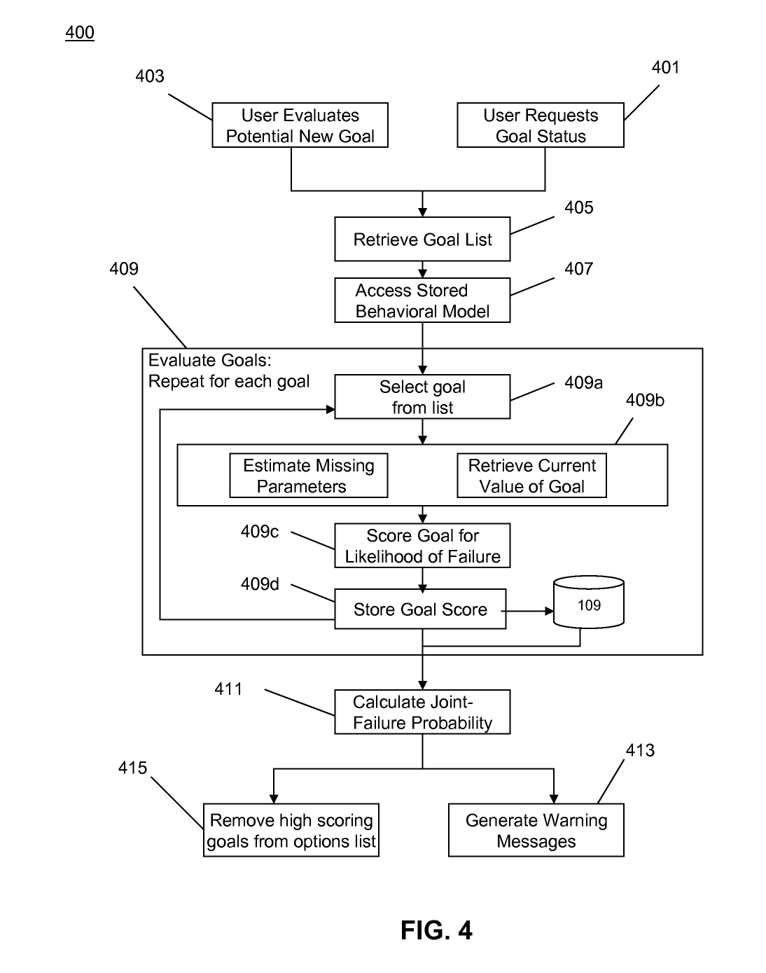

To forecast goal achievement, application 103 may employ a predictive model of the likelihood of individual users completing a goal, given the goal type, financial target, and personal characteristics of the user. FIG. 4 illustrates a process 400, which is an example of goal achievement forecasting according to various implementations of the invention. Process 400 may include an operation 401, wherein a user requests goal status of a goal associated with the user. In some instances, process 400 may also begin with an operation 403, wherein goal achievement forecasting is used when a user evaluates a potential new goal. In an operation 405, application 103 retrieves a list of goals associated with the user (and/or a list of potential new goals for the user). In an operation 407, application 103 accesses a stored behavioral model associated with the user. In some implementations, the stored behavioral model may utilize data regarding the user's earnings, spending habits, investment, saving habits, and/or other data regarding the user. In some embodiments, a stored behavioral model may utilize data and/or estimations/derivations from other users or groups of users (e.g., other users sharing characteristics with a particular user).

In an operation 409, application 103 may evaluate one or more goals on the goal list in light of the accessed behavioral model. In some instances, goal evaluation may include an operation 409a, wherein a goal from the list of goals is selected. In an operation 409b the current value of the selected goal may be retrieved and any missing parameters may be estimated using information known by system 101. In an application 409c application 103 may score the goal in light of its associated user for its likelihood of failure. In some implementations, scoring may entail executing a stored behavioral model with a given user's personal and/or behavioral characteristics as input. The model may then return a probability [0,1] of default. In some instances, this probability of default may be weighted by the severity of the failure and/or normalized across other goals/users to generate a failure score [0,1]. In some instances, a raw probability of failure may be used as a score. In an operation 409d, the goal score may be stored by system 101 (e.g., in one of databases 109a-109n). If multiple goals are to be analyzed, process 400 may return to operation 409a, wherein a second goal from the list may be selected.

In an operation 411, application 103 may apply a secondary model to the constellation of all analyzed goals for the user so as to determine a score to joint probability of failure for a user across all of the users analyzed goals. In some instances, an individual may have a high likelihood of completing a goal when it is evaluated individually. However, when the goal is evaluated in tandem with additional goals, completion of the goal may be unrealistic (e.g., in an extreme case, a user having 1000 goals to save $1000). In some implementations, application 103 may evaluate any overlap between goals, in terms of resources, user attention required, and/or other factors and recalculates a joint failure probability.

In an operation 413, application 103 may then analyze the user's preferences and prior responses to notifications to determine the appropriate threshold (likelihood of default) at which to generate notifications to the user. These determined notifications may then be added to the messaging system to warn the user. In an instance where a user initiated process 400 by requesting the status of goals, high scoring goals, (i.e., those with a high likelihood of failure) may be given precedence in user interface module 107a and messaging engine 107g. In an instance where a user initiated process 400 by requesting potential new goals, high scoring goals (those with a high likelihood of failure) may not be displayed at all (e.g., removed from the list of available goals in an operation 415) or annotated with an appropriate warning. Low and medium scoring goals (those with a low or medium likelihood of failure) may also be annotated with appropriate encouragement for the user to undertake such feasible goals.

The above described evaluation of a user's likelihood of success for one or more goals may also be utilized as part of an automatic goal creation/suggestion process wherein application 103 mines data relating to the user to determine one or more goals to create or suggest for the user.

As discussed herein, application 103 may utilize behavioral models to select appropriate notification content. In some instances, application 103 may employ a predictive model of the impact of goal-related messages on goal achievement (e.g., for individual messages and/or sequences of messages over time), given the goal type, financial target, goal progress, prior messages, and personal characteristics of the user. As such, one or more databases 109a-109n of system 101 may store a wide range of possible goal-related messages, and use the predictive model to select the appropriate message. For example, if a user is failing to meet a goal to save for their child's college education at a particular school, application 103 can evaluate whether alternative schools would fit the user's requirements (leading to a “revise your goals” message), or whether the user has previously fallen behind on goals but eventually completes them (leading to a “you've done so well in the past” message).

As discussed herein, application 103 may utilize behavioral models to automatically select appropriate and/or interesting goals. In some instances, application 103 may generate models of which goals are likely to interest the user, given the user's personal characteristics, including demographics and financial profile. The user can then access all (applicable) goals at will, but goals that are judged to be most compelling to the user may be given prominence in a graphical user interface displayed to the user when the user is selecting goals.

As discussed herein, application 103 may store detailed information on each user's actions with regard to system 101. In some instances application 103 may use a unique, non-personally identifiable code for each individual user. The detailed information regarding user actions may include a user's history of goal creation, progress towards a goal, goal completion, user responses to notification messages, and/or other information.

In some implementations, application 103 may recalibrate behavioral models of user behavior based on anonymized data from all users in the system, integrating external behavioral data where internal user records are insufficient. To provide this functionality, behavioral modeling engine 107f may incorporate complete statistical and data mining (predictive market segmentation) capabilities to calibrate and apply behavioral models. In some instances, initial models may be developed outside of system 101 and subsequently embedded into a database of system 101 (e.g., a database 109) with, for example, Predictive Model Markup Language, proprietary modeling languages, or other modeling languages.

In some implementations the behavioral models used by application 103 may analyze individual characteristics (e.g., payment history, age, income, existing goal set, or other characteristics) to determine the probability of actions described herein (e.g., failure to achieve a goal, willingness to undertake a goal, responsiveness to messages, or other actions). As set of feature selection techniques may be used to determine the relevant streams of data to incorporate into each model. Such techniques may include: incremental feature addition, backwards elimination, genetic algorithms, and/or other techniques. Models may then be developed via supervised or unsupervised machine learning algorithms and direct human specification. Modeling technologies used may include classification and regression trees, boosted Bayesian classifiers, and multivariate nonlinear response models. In some instances, when considerable processing power is required for behavioral modeling analysis, it may be farmed out to an on-demand compute cloud (e.g., compute cloud 201 in FIG. 2).

In some implementations, as application 103 gathers data about user behavior, it may automatically recalibrate the behavioral models in system 101 to incorporate the new data. Behavioral modeling engine 107j may track the accuracy of its own predictions, and may notify system administrators when its internal recalibration procedure is not achieving a predetermined expected increase in predictive accuracy. In some instances, the system administrators may then manually review the functional form for potential improvements, given the newly compiled behavioral data.

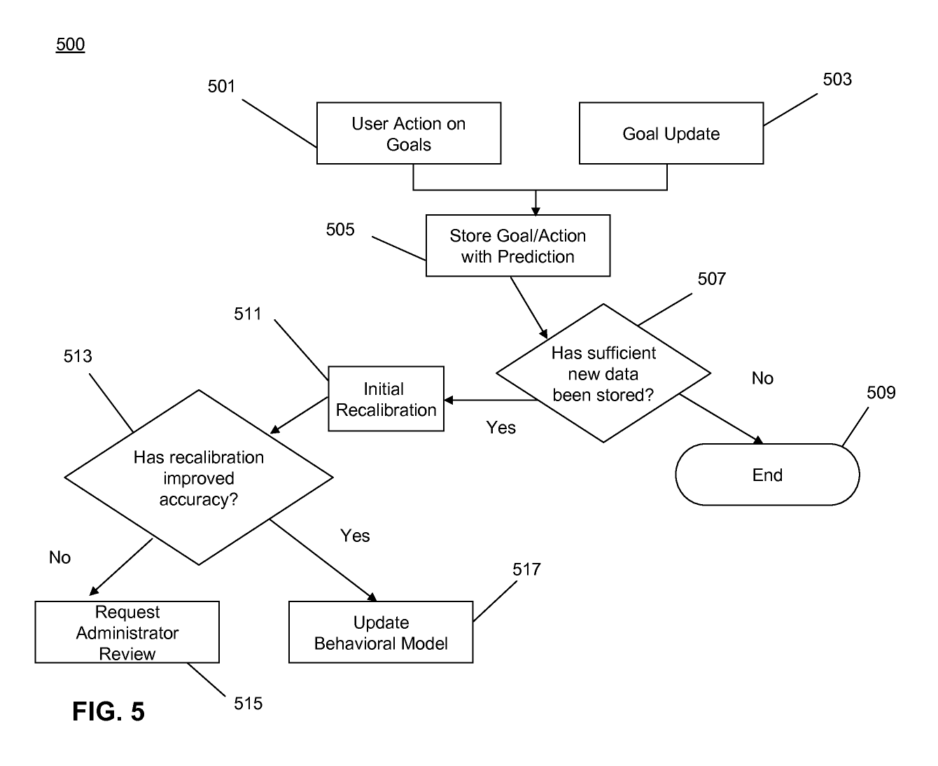

FIG. 5 illustrates a process 500, which is an example of a process for recalibrating behavioral models according to various embodiments of the invention. Process 500 may include an operation 501 wherein a user action is recorded by application 103. In some instances, process 500 may be initiated in an operation 503 when goal creation engine 107b or goal tracking engine 107e calculates a score for a given goal (see e.g., process 400 described herein) and this revised information is provided to behavior modeling engine 107f. In an operation 505, the goal update or user action may be stored by application 103 along with any previous predictions regarding the user (e.g., predictions relating to user actions or associated goals). In an operation 507, application 103 may determine whether sufficient new data has been accrued to update stored behavioral models: i.e., whether the new information regarding actual performance can be used to provide a better model of future performance (for each of the behaviors under consideration, including goal success, message response, goal initiation, and/or other behaviors). If not, process 500 ends (as illustrated by object 509). If sufficient new data has been stored, an initial recalibration is performed in an operation 511. The recalibration process may entail estimating the parameters of the stored behavioral model through a statistical regression or optimization procedure. In an operation 513, it is determined whether the initial recalibration has successfully improved accuracy, as measured by cross-validation and out of sample testing. If not, then an administrator review is requested in an operation 515. If the recalibration has improved accuracy, the behavior model is updated with the recalibrated model in an operation 517.

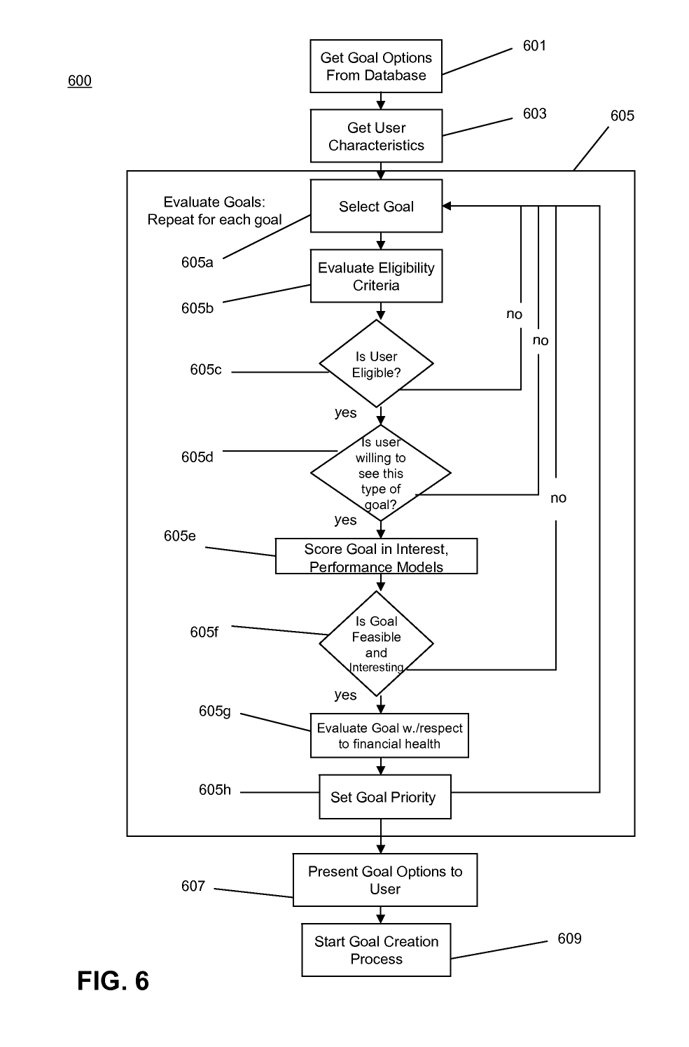

In some implementations, application 103 may assist users to select one or more appropriate goals. For example, in some instances, application 103 may guide users to select appropriate goals based on their personal characteristics and/or predicted performance on those goals. In some implementations, automated creation/suggestion of goals for users may be part of features/functions of application 103 that enable suggestions to users of how to “grow” their money or otherwise increase their wealth using readily available financial tools and methodologies. The one or more modules 107a-107n of application 103 may utilize the data known regarding a given user and run one or more simulations to determine how the user can optimally grow his or her wealth. These simulations may include estimations of any number of given variables at any number of given points. As such, the process for assisting users with goal selection provided herein may utilize behavioral models, market projections, and/or statistical models to supply data for these estimations. However, even though a large number of variables may need to be estimated, the determination of whether to run a given simulation may be largely based on information known about a user. FIG. 6 illustrates a process 600, which is an example of a semi-automated process for goal selection/creation/suggestion according to various implementations of the invention.

Process 600 may include an operation 601 wherein all of the available goals from system 101 may be selected from a database of system 101 (e.g., a database from 109a-109n). In an operation 603, the characteristics/user information associated with a particular user may be accessed/retrieved/derived or otherwise obtained. In an operation 605, each of the goals from the available goal set is evaluated with respect to the user characteristics (e.g., the user information is applied to stored goal information associated with the available goals). This evaluation serves as a filter for the set of all possible goals to remove goals for which the user is not suited or eligible. For example, if the user does not own a home, then goals regarding home improvements would not be displayed.

In some implementations, evaluation of goals in light of user characteristics may include an operation 605a wherein a goal from the set of available goals is selected. In an operation 605b, any eligibility criteria are evaluated in light of the user's characteristics. In an operation 605c, it is determined whether the user meets the eligibility/qualification criteria (if any). If the user does not meet the eligibility criteria, the selected goal is discarded and process 600 returns to operation 605a, wherein a new goal from the list of available goals is selected for evaluation. If the user does meet the eligibility criteria, process 600 may proceed to an operation 605d, wherein it is determined whether the user characteristics indicate that the user is open or willing to participate in a goal of the selected type. If the user is not willing to participate in a goal of the selected type, the selected goal is discarded and process 600 returns to operation 605a, wherein a new goal from the list of available goals is selected. If the user is willing to participate (or if no such preference exists in the user's characteristics), process 600 proceeds to an operation 605e wherein the user's interest in and likelihood of success for the selected goal is predicted (e.g., using one or more behavioral models and/or behavioral modeling engine 107f). In an operation 605f, it may be determined whether the goal is feasible for (i.e, the user is able to succeed within a predetermined likelihood of success) and/or interesting to (i.e., matches with the user's interests/lifestyle/etc.) the user. If it is determined that the user is not likely to success and/or be interested in the goal, process 600 may return to operation 605a, wherein a new goal from the list of available goals may be selected. If it is determined that the selected goal may be feasible and/or interesting to the user, process 600 may proceed to an operation 605g, wherein the selected financial goal may be evaluated with respect to the user's financial health.

In some implementations, evaluation of a goal in light of a user's financial health may include prioritizing and selecting potential goals based on a “hierarchy of financial health.” The hierarchy of financial health may include a detailed model of the steps needed to improve individual financial health, based on years of academic and professional research on consumer financial behavior. Application 103 may analyze each individual's financial and personal circumstances, to determine which actions are most likely to protect the individual from financial catastrophe, build savings for financial goals, ensure a comfortable retirement, and/or meet other criteria. For many individuals, for example, a first step towards financial health may include setting aside emergency savings in case of personal or financial trouble. Later steps may include establishing retirement savings, college savings, etc, depending on the individual's life circumstances.

In an operation 606h, the selected goal may then be selected for presentation to the user (note: if additional goals are to be presented to the user, process 600 may return to operation 605a wherein a new goal may be selected from the list of financial goals) and/or prioritized among other goals selected for presentation to the user. In an operation 607, the selected goal, and its various options, may be presented to the user (displayed on a client computer associated with the user) via a graphical user interface. In an operation 609, the goal creation process (e.g., as described herein in reference to FIG. 3) may be initiated. In some implementations, the goal creation process may include creating a proposed instance of a goal that the user qualifies for or for which it is otherwise determined that the user desires, is likely to complete, would be beneficial for the user, or otherwise filtered for presentation to the user (e.g., using operations 605a-605h). Creation of the proposed goal instance may include populating an instance of a given goal using known information relating to a user such as, for example, personal information, and financial information (e.g., a user's income, number of children mortgage balance, may be used to populate a proposed goal instance). This information may be known by system 101 based on previous input from the user (e.g., if the user utilizes system 101 as a financial management tool, the user may have already input financial and/or personal information), information derived from financial institution systems (e.g., 117a-117n), information from other goals the user is associated with, and/or user information that has otherwise previously been received and stored. In some instances, information may be estimated (see e.g., description of FIG. 3) using information relating to other users, behavioral models, and/or techniques. In some instances, additional information may be needed to create the proposed goal instance. Thus, similar to the description of FIG. 3, the user may be presented with one or more questions to provide the additional information. However, as the proposed goal instance was automatically created, in some instances, these questions need not be asked until after the proposed goal instance has been displayed to a user and the user has indicated that participation in the proposed goal instance is desired.

In some implementations, application 103 may enable suggestion and/or management of incentives related to goals. For instance, application 103 may be associated with one or more “partners” that may offer a diverse set of incentives to encourage users to complete their financial goals. Application 103 may couple with and/or integrate with the disparate incentive systems of these partners to generate a common façade (i.e., interface) to all incentives Application 103 may then assist the user in selecting appropriate incentives based on personal characteristics and predicted performance on their goals after the incentives applied.

In some implementations, application 103 may employ web-services to access systems (e.g., systems 115a-115n in FIG. 1) of disparate incentive providers (i.e. partners), including coupon providers, promotional offers, small product donations, and/or other incentive providers. In some implementations, application 103 may integrate the incentives offerings of each provider into a common system, which may express the terms and conditions, dollar value, and relevant goals associated with each incentive. As such, all of the information regarding numerous incentive providers may be accessed through an internal façade or interface, which provides incentive information to other components of system 101.

As described herein, when a user creates a new goal, application 103 may filter the set of all possible incentives to remove incentives that are not appropriate for the user and/or goal. Also as described herein, application 103 may access behavioral modeling engine 107f to determine the likelihood of interest in the incentive and/or the impact of the incentive on goal success (when data is available on the goal). Furthermore, as described herein application 103 may display the resulting filtered, prioritized, incentive suggestions in a user interface as part of the goal creation process.

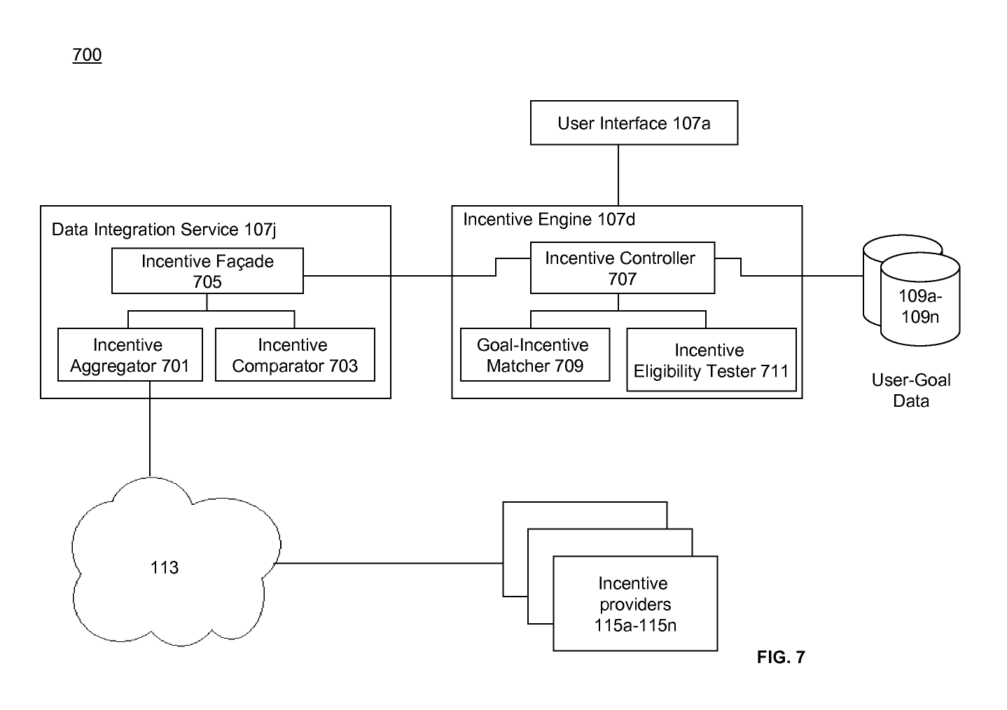

FIG. 7 illustrates a configuration 700, which is an example of certain components system 101 that may be used as part of an incentive system, according to various embodiments of the invention. Configuration 700 illustrates that data integration service 107j may include an incentive aggregator 701, which may interface with incentive provider systems 115a-115n to return metadata (and/or other data) regarding their incentives and supply the raw data to an incentive façade 705. In some implementations incentive aggregator 701 may be, include, and/or utilize one or more web services to communicate with incentive provider systems 115. Incentive façade may process the individual incentives into a consistent framework, employing an incentive comparator 703 and may provide access to the (standardized) incentive information to incentive engine 107d. As discussed herein, incentive façade 705 may serve an internal interface (e.g., for administrators or for use in providing incentive information to users) within system 101 for all incentive providers.

Configuration 700 also illustrates that incentive engine 107d may include an incentive controller 707 that may manage incentives with respect to users and/or goals of application 103, including accessing incentive information from data integration service 107j's incentive façade 705, retrieving user and goal information from database 109, selecting appropriate incentives using a goal-incentive matcher 709, testing a user's eligibility for a given incentive using an eligibility tester 711, providing a user interface with information about selected incentives. As illustrated in FIG. 7, data integration service 107j and incentive engine 107d may utilize one or more databases 109a-109n and/or user interface module 107a to retrieve/store information and display information to users or administrators.

In some implementations, application 103 may integrate goals and incentives with system 101. For example, as discussed herein, application 103 may determine appropriate goal information for the user, including suggestions for new goals, notifications about existing goals and incentives, and/or other information, and present it to users via one or more graphical user interfaces. In some implementations, application 103 may analyzes meta-information accompanying each user communication (i.e., each user interface element on each web page, each email message) to determine whether the goal or incentive information would be relevant for the user. Application 103 may then analyze the goal information priority, user preferences regarding goal information, and the amount of information that can be included in the user communication without overwhelming the user. As appropriate, application 103 may then select one or more high priority items for communication to the user. The high-priority goal information may then be “injected” into a user communication (e.g., web page, email message).

In some implementations, system 101 may enable user interface experimentation to perform one or more tests, such as, for example, interface design tests, and/or other tests. Application 103 brings a scientific approach to helping users meet their financial goals and recognizes that the psychology of financial management is currently insufficiently understood in both the professional and academic arenas. Part of the challenge of financial goal-making is to provide a trusted, easy to use environment in which to learn about financial issues and take action. In addition to external focus groups and usability tests, Application 103 may incorporate experimental user interface testing into the application itself, to help inform application design. This functionality may be particularly useful when predictive models do not have sufficient data to make accurate forecasts on the impact of notification messages, or system administrators would like to test new user interface components.

In some implementations, application 103 enables one or more system administrators to establish alternative, parallel user interface components, including but not limited to entire web pages, widgets, goal descriptions, notification messages and/or other components. Application 103 may also enable system administrators to define sampling procedures so as to randomly select from populations of interest. For example, administrators can select uniform, stratified or clustered sample designs, based on any (anonymous) information stored about users of the system such as, for example, city of residence, age, income, financial health, and prior goal performance.

Application 103 may also enable administrators to schedule and execute the user interface experiments, in which treatment groups may be provided with a set of alternative user interface elements (e.g., a control group receives either the existing user interface elements or no relevant element, depending on the status quo). Application 103 may also enable administrators to track immediate user behavior under each case, and log user treatments for longer term analyses. Furthermore, application 103 may also provide the resulting data to system administrators in formats readily accessible to standard statistical analysis packages for analysis.

In some implementations, system 101 may enable the creation, editing, and tracking of special-purpose financial product plans, which can be considered goals within system 101 as they provide a concrete plan for product purchase given a user's current needs. As such, this product recommendation/suggestion feature may be utilized in concert with manual and/or automatic goal creation/recommendation process described herein. For example, application 103 may utilize information relating to a given user and apply the information to a database or other data store of financial products to produce a recommended product purchase plan.

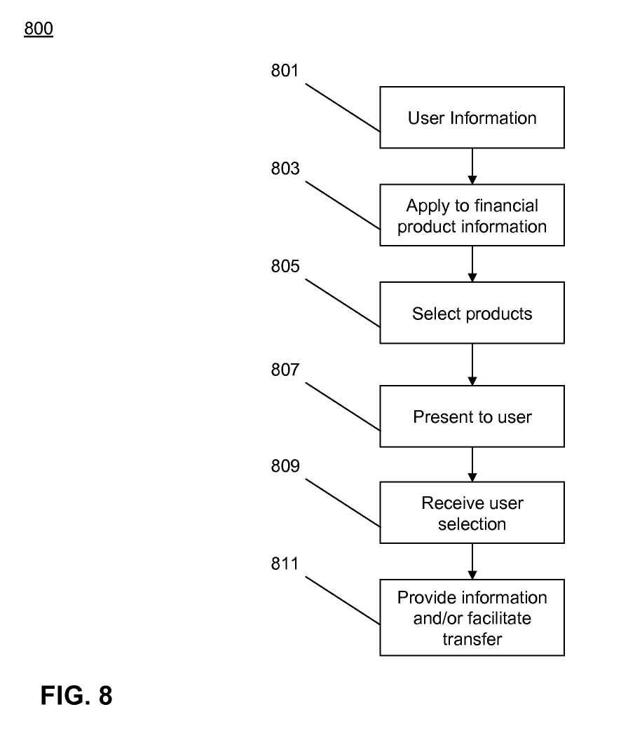

FIG. 8 illustrates a process 800, which is an example of a process for selecting/recommending one or more financial products to one or more users. Process 800 may include an operation 801, wherein information relating to a user may be received and/or gathered. This information may include information relating to the user's finances (e.g., accounts, income, existing financial products, etc.), personal information (e.g., age, marital status, number of children, address), information related to one or more goals associated with the user (e.g., wants to retire at age 65, has 2 children that need to go to college, wants to buy vacation home, etc.) and/or other information. This information may be mined/gathered from data that system 101 already stores regarding the user (e.g., information used in other portions of the system such as, for example, information used for goal creation, or other features described herein), may be gathered or received from other sources (financial institutions, public data sources, or other third party data sources), may be received from the user (e.g., in response to a question or specific request), and/or from other sources.

In an operation 803, the user information may be used to analyze stored financial product information. The stored financial product information may include information relating to available financial products such as, deposit accounts, checking accounts, money market accounts, certificates of deposit, mutual funds, bonds, stocks, loans, credit, or other financial products. Information relating to these products may include any information describing specific metrics, characteristics, or requirements for a given product such as, for example, the name of one or more institutions/entities offering the product or otherwise associated therewith, branch locations of those institutions/entities, a minimum balance or purchase price, an interest rate, an estimated rate of return, any relevant date, timing, or maturity information, any qualifying information (e.g., characteristics necessary for the product to be available to the user), and/or other information. Information relating to available financial products may have previously been gathered/received by system 101 and stored in databases 109a-109n.

In some implementations, application of user information to the financial product information may include comparison of the user information to eligibility or qualification criteria associated with the one or more financial products and the applicability of the product to the user's existing and recommended goals. For example, certain products (e.g., certificates of deposit, deposit accounts) may have a specified minimum balance and/or risk reward characteristics. If the user information indicates that the user has the ability (in a practical sense and/or in an absolute sense) to purchase the products, then the user may be determined to be eligible for the product. Other types of eligibility/qualification determinations may be made.

In some implementations, application of user information to the financial product information may include determining, based on the user information and the financial product information, which financial products would provide a benefit to the user. For example, in some instances, a certain financial product (e.g., deposit account) may provide a better interest rate than one a user is currently using. It may be also be determined that the cost of switching from the user's current product to the product with a higher interest rate may not be prohibitive or my not outweigh the benefit of the higher interest rate. In some instances, it may be determined that adding or switching to a given financial product may assist in a user achieving one or more goals (e.g., a goal the user has already created or a goal that is suggested). As such, process 800 may be used in concert with assisting users to achieve other goals and/or with suggesting other goals for a user as described herein.

Process 800 may include an operation 805, wherein one or more financial products from the stored financial product information are selected. As discussed above, these may be selected because they represent the products that the user qualifies for and are appropriate to the user's financial needs. They may be selected because they represent the products that may benefit the user when compared to the user's “status quo.” Other strategies and/or methodologies may be used to select financial products from the financial product information when user information is applied thereto.

In an operation 807, the selected financial products may be presented to the user (e.g., to a user computer via a GUI). In an operation 809, the user may select (and system 101 may receive), one or more of the presented financial products. After the user has selected one or more financial products, system 101 may provide additional information regarding the products selected by the user and/or may facilitate purchase of the products selected by the user in an operation 811. In some implementations, facilitating purchase may include simply providing contact information regarding an entity/financial institution that provides the product. In some implementations, facilitating purchase may include providing a link to a website of the entity/financial institution that provides the product. In some implementations, facilitating purchase may include enabling the user to purchase the product via a GUI of application 103.

In some implementations, a user may be able to edit and track progress against the previously determined financial product plan. This process may include notifications about changes in the availability and characteristics of products, or allow the user to re-execute the product recommendation analysis given updated information with respect to savings and spending behavior. System 101 may provide for automatic notifications to the user related to their financial product plan, and/or recommend new product plans based on the user information and product information described above.

In some implementations, system 101 may include or may be part of a system for general personal financial management. For example, application 103 may include modules that support or may interface with modules that provide maintenance of a user's financial accounts. Such maintenance and management may include analyzing deposits, withdrawals, balances, charting and categorizing expenditures, capital gains/losses, and other money monitoring features. As such, application 103 and/or other parts of system 101 may employ access to user financial and personal information and may use this to provide more robust and intelligent features.

In some implementations, the invention may include tangible computer-readable media having computer-readable instructions stored thereon. The computer readable instructions may be used to configure one or more processing devices for performing and/or causing one or more processing devices to execute some or all of the features and functions of the various described implementations of the invention described herein.

The systems and methods described herein are provided as examples only. Those having skill in the art will appreciate that the invention described herein may work with various system configurations and that other order of operations may exist for the processes/methods described herein. Accordingly, more or less of the aforementioned system components may be used and/or combined in various embodiments. Additionally, additional operations for methods may be performed while others may be omitted and/or operations may be performed in different orders. In some implementations, as would be appreciated, the functionalities provided by application 101 and the various modules 107a-107n described herein may be implemented in various combinations of hardware and/or firmware, in addition to, or instead of, software.

While the invention is described herein with regard to “users” and may be interpreted as relating to personal financial management for individuals and/or families, the systems and methods of the invention may also be utilized for corporate and/or other entities as users and need not be limited to personal use.

While the invention has been described with reference to the certain illustrated embodiments, the words that have been used herein are words of description, rather than words of limitation. Changes may be made, within the purview of the associated claims, without departing from the scope and spirit of the invention in its aspects. Although the invention has been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of claims filed herewith or afterwards filed.

We claim:

1. A system for creation and tracking of personal financial goals, the system comprising:
at least one data storage device that stores:
user information for one or more users, the user information including one or more of financial information or personal information, and
goal information for a plurality of predefined financial goals; and
one or more processing devices configured to:
automatically apply user information relating to a user from the one or more users to goal information for one or more of the plurality of predefined financial goals,
automatically select at least one financial goal from the plurality of financial goals for the user based on whether the application of the user information to the goal information for the one or more predefined financial goals indicates that the user qualifies to participate in the at least one financial goal,
automatically create a proposed instance of the at least one selected financial goal using the goal information and the user information for the user, and
present the proposed instance of the at least one at least one selected financial goal to a computing device associated with the user.

2. The system of claim 1, wherein the one or more processors configured to automatically create a proposed instance of the at least one selected financial goal are further configured to populate the proposed instance of the at least one selected financial goal using the user information.

3. The system of claim 2, wherein the one or more processors configured to populate the proposed instance of the at least one selected financial goal are further configured to populate one or more predefined characteristics or metrics of the proposed instance of the at least one selected financial goal with values derived from the user information.

4. The system of claim 2, wherein the user information used to populate the predefined characteristics or metrics of the proposed instance of the at least one selected financial goal includes one or more of user information associated with the user or estimated information derived from additional users from the one or more users.

5. The system of claim 1, wherein the one or more processing devices are further configured to receive, from the computing device associated with the user, an indication that the user desires to participate in the proposed instance of the at least one selected financial goal.

6. The system of claim 1, wherein the one or more processing devices configured to present the proposed instance of the at least one selected financial goal include one or more processing devices further configured to display one or more actions to be taken by the user necessary to achieve the proposed instance of the at least one selected financial goal.

7. The system of claim 6, wherein the one or more processors are further configured to:
receive additional user information regarding the user, wherein the additional information includes one or more of information received from the user or estimated information;
update the at least one data storage device with the additional user information; and
modify the displayed one or more actions according to the additional user information.

8. The system of claim 1, wherein the proposed instance of the at least one selected financial goal includes saving funds for use for a specified purpose at a specified time in the future.

9. The system of claim 8, wherein the one or more processing devices are further configured to:
receive funding information regarding the amount of funds necessary for the specified purpose at the specified time;
store the funding information in the at least one data storage device; and
determine, using the stored funding information and the user information relating to the user, one or more actions to be performed by the user to achieve the proposed instance of the at least one financial goal, wherein the determined one or more actions include a specified sequence; and
present the determined one or more actions to the computing device associated with the user.

10. The system of claim 9, wherein the one or more processing devices are further configured to:
receive information relating to performance of the one or more determined actions;
modify the one or more determined actions based on the received information relating to performance of the one or more determined actions.

11. A method for creation and tracking of personal financial goals, the method being executed by one or more processing devices configured by computer-executable instructions to perform a plurality of operations comprising:
receiving user information for one or more users, the user information including one or more of financial information or personal information;
automatically applying user information relating to a user from the one or more users to goal information for one or more of a plurality of predefined financial goals;
automatically selecting at least one financial goal from the plurality of financial goals for the user based on whether the application of the user information to the goal information for the one or more predefined financial goals indicates that the user qualifies to participate in the at least one financial goal;
automatically creating a proposed instance of the at least one selected financial goal using the goal information and the user information for the user; and
present the proposed instance of the at least one at least one selected financial goal to a computing device associated with the user.

12. The method of claim 11, wherein automatically creating a proposed instance of the at least one selected financial goal are further comprises populating the proposed instance of the at least one selected financial goal using the user information.

13. The method of claim 12, wherein populating the proposed instance of the at least one selected financial goal further comprises populating one or more predefined characteristics or metrics of the proposed instance of the at least one selected financial goal with values derived from the user information.

14. The method of claim 12, wherein the user information used to populate the predefined characteristics or metrics of the proposed instance of the at least one selected financial goal includes one or more of user information associated with the user or estimated information derived from additional users from the one or more users.

15. The method of claim 11, wherein the plurality of operations further comprise receiving, from the computing device associated with the user, an indication that the user desires to participate in the proposed instance of the at least one selected financial goal.

16. The method of claim 11, wherein presenting the proposed instance of the at least one selected financial goal further comprises displaying one or more actions to be taken by the user necessary to achieve the proposed instance of the at least one selected financial goal.

17. The method of claim 16, wherein the plurality of operations further comprise:
receiving additional user information regarding the user, wherein the additional information includes one or more of information received from the user or estimated information;
updating the at least one data storage device with the additional user information; and
modifying the displayed one or more actions according to the additional user information.

18. The method of claim 11, wherein the proposed instance of the at least one selected financial goal includes saving funds for use for a specified purpose at a specified time in the future.

19. The method of claim 18, wherein the plurality of operations further comprise:
receiving funding information regarding the amount of funds necessary for the specified purpose at the specified time;
storing the funding information in the at least one data storage device; and
determining, using the stored funding information and the user information relating to the user, one or more actions to be performed by the user to achieve the proposed instance of the at least one financial goal, wherein the determined one or more actions include a specified sequence; and
presenting the determined one or more actions to the computing device associated with the user.

20. The method of claim 19, wherein the plurality of operations further comprise:
receiving information relating to performance of the one or more determined actions; and
modifying the one or more determined actions based on the received information relating to performance of the one or more determined actions.
